(19) United States
(12) Patent Application Publication
(10) Pub. No.: US 2019/0058731 A1
(43) Pub. Date: Feb. 21, 2019

(54) USER-SIDE DETECTION AND CONTAINMENT OF ARP SPOOFING ATTACKS

(71) Applicant: QUALCOMM Incorporated, San Diego, CA (US)

(72) Inventors: Pankaj GARG, San Diego, CA (US); Subrato Kumar DE, San Diego, CA (US); Sajo Sunder GEORGE, San Diego, CA (US); Shyama Prasad MONDAL, San Diego, CA (US); Dineel SULE, San Diego, CA (US)

(21) Appl. No.: 15/879,334

(22) Filed: Jan. 24, 2018

Related U.S. Application Data
(60) Provisional application No. 62/547,005, filed on Aug. 17, 2017.

(51) Int. Cl. H04L 29/06; H04L 29/12

(52) U.S. Cl. CPC H04L 63/1483; H04L 63/0236; H04L 61/2007; H04W 84/12; H04L 61/6022; H04L 61/6009; H04L 61/103

(57) ABSTRACT

Aspects of the disclosure are related to a method, comprising: detecting an incorrect first address to second address mapping in an Address Resolution Protocol (ARP) cache of one or more of: a user device or a gateway device; and performing one or more containment operations, wherein the containment operations comprise one or more of: transmitting an ARP request message that requests an Internet Protocol (IP) address to Media Access Control (MAC) address mapping for a gateway device onto a subnetwork, transmitting an ARP message that comprises an IP address to MAC address mapping for a user device onto the subnetwork, or alerting a user.

### CROSS-REFERENCE TO RELATED-APPLICATIONS

This application claims the benefit of U.S. Provisional Patent application Ser. No. 62/547,005 entitled “USER-SIDE DETECTION AND CONTAINMENT OF ARP SPOOFING ATTACKS” which was filed Aug. 17, 2017. The entirety of the aforementioned application is herein incorporated by reference.

### FIELD

The subject matter disclosed herein relates, in general, to electronic devices, and in particular, to an apparatus, system, and method for detecting and containing ARP spoofing attacks.

### BACKGROUNDS

The Address Resolution Protocol (ARP) is stateless protocol used for resolution of Internet layer addresses (e.g., Internet Protocol version 4 “IPv4,” or simply “IP,” addresses, which are Layer 3 “network layer” addresses) into link layer addresses (e.g., Media Access Control “MAC” addresses, which are Layer 2 “data link layer” addresses). The new Internet Protocol version6 (IPv6) uses Neighbor Discovery Protocol (NDP) to perform similar functions as those of ARP. The default basic NDP without authentication is similar to ARP and suffers the same vulnerabilities as ARP. In other words, ARP may be used for mapping a network address (e.g., an IP address) to a physical address (e.g., a MAC address). Hereinafter any reference to the ARP shall refer to either the ARP or the default basic NDP that lacks message authentication, as appropriate.

An ARP cache is a collection of ARP entries (IP address to MAC address mappings). It is constructed based on ARP messages received over the network and may be maintained at a networked device (e.g., a computer, a smartphone, etc.), such that a new ARP query is not required for every data frame.

The ARP has been in existence since the beginning of IP networking, and despite proposals from both academia and the industry, has not changed much due to the potential risk of breaking backward compatibility or legacy networks.

ARP spoofing (also known as ARP cache poisoning or ARP poison routing) is a technique by which an attacker sends spoofed ARP messages onto a local area network. Generally, the aim is to associate (in the victim's ARP cache) the attacker's MAC address with the IP address of another host, such as the default gateway, causing any traffic meant for that IP address to be sent to the attacker instead. ARP spoofing may allow an attacker to intercept data frames on a network, modify the traffic, or stop all traffic. Often the attack is used as an opening for other attacks, such as denial of service (DoS), man in the middle (MITM), or session hijacking attacks.

ARP spoofing is one of the most dangerous forms of network attacks. It takes place mainly because ARP is stateless, and lacks any built-in mechanism of verifying the identity of the host sending an ARP message. Detection, mitigation, and prevention of the problems associated with ARP spoofing can stop many network attacks.

Vendors of network devices have been providing ARP spoofing detection and prevention solutions with their routers and gateways. These solutions largely depend on the ability of detecting suspicious ARP messages and blocking them on the network side. The effectiveness of these network side solutions may vary depending on the abilities and sophistication of the various network device vendors.

The network side solutions are only a piece of the puzzle, as an otherwise unprotected client device is at the mercy of the quality and effectiveness of the network side solution that is actually deployed in terms of the protection against ARP spoofing.

### SUMMARY

An aspect of the disclosure is related to a method, comprising: detecting an incorrect first address to second address mapping in an Address Resolution Protocol (ARP) cache of one or more of: a user device or a gateway device; and performing one or more containment operations, wherein the containment operations comprise one or more of: transmitting an ARP request message that requests an Internet Protocol (IP) address to Media Access Control (MAC) address mapping for a gateway device onto a subnetwork, transmitting an ARP message that comprises an IP address to MAC address mapping for a user device onto the subnetwork, or alerting a user.

### BRIEF DESCRIPTION OF THE DRAWINGS

FIG. 1 is a block diagram illustrating an example environment in which embodiments of the disclosure may be practiced.

FIG. 2A is a block diagram illustrating an example scenario in which no ARP cache compromise has occurred.

FIG. 2B is a block diagram illustrating an example scenario in which the ARP cache of the user device is compromised.

FIG. 2C is a block diagram illustrating an example scenario in which the ARP cache of the gateway device is compromised.

FIG. 2D is a block diagram illustrating an example scenario in which the ARP caches of both the gateway device and the user device are compromised.

FIG. 3 is a flowchart illustrating an example method for containing an ARP spoofing attack.

FIG. 4 is a flowchart illustrating an example method for containing an ARP spoofing attack that compromises an ARP cache of the user device.

FIG. 5 is a flowchart illustrating an example method for containing an ARP spoofing attack that compromises an ARP cache of the gateway device.

FIG. 6 is a flowchart illustrating an example method for containing a DHCP spoofing attack.

### DETAILED DESCRIPTION

Aspects of the disclosure are disclosed in the following description and related drawings directed to specific embodiments of the disclosure. Alternate embodiments may be devised without departing from the scope of the disclosure. Additionally, well known elements of the disclosure may not be described in detail or may be omitted so as not to obscure the relevant details of the disclosure.

The word “exemplary” is used herein to mean “serving as an example, instance, or illustration.” Any embodiment described herein as “exemplary” is not necessarily to be construed as preferred or advantageous over other embodiments. Likewise, the term “embodiments” does not require that all embodiments include the discussed feature, advantage or mode of operation.

The terminology used herein is for the purpose of describing particular embodiments only and is not intended to be limiting of embodiments of the disclosure. As used herein, the singular forms “a”, “an” and “the” are intended to include the plural forms as well, unless the context clearly indicates otherwise. It will be further understood that the terms “comprises”, “comprising”, “includes” and/or “including”, when used herein, specify the presence of stated features, integers, steps, operations, elements, and/or components, but do not preclude the presence or addition of one or more other features, integers, steps, operations, elements, components, and/or groups thereof.

Further, many embodiments are described in terms of sequences of actions to be performed by, for example, elements of a computing device (e.g., a server or device). It will be recognized that various actions described herein can be performed by specific circuits (e.g., application specific integrated circuits), by program instructions being executed by one or more processors, or by a combination of both. Additionally, these sequences of actions described herein can be considered to be embodied entirely within any form of computer readable storage medium having stored therein a corresponding set of computer instructions that upon execution would cause an associated processor to perform the functionality described herein. Thus, the various aspects of the disclosure may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

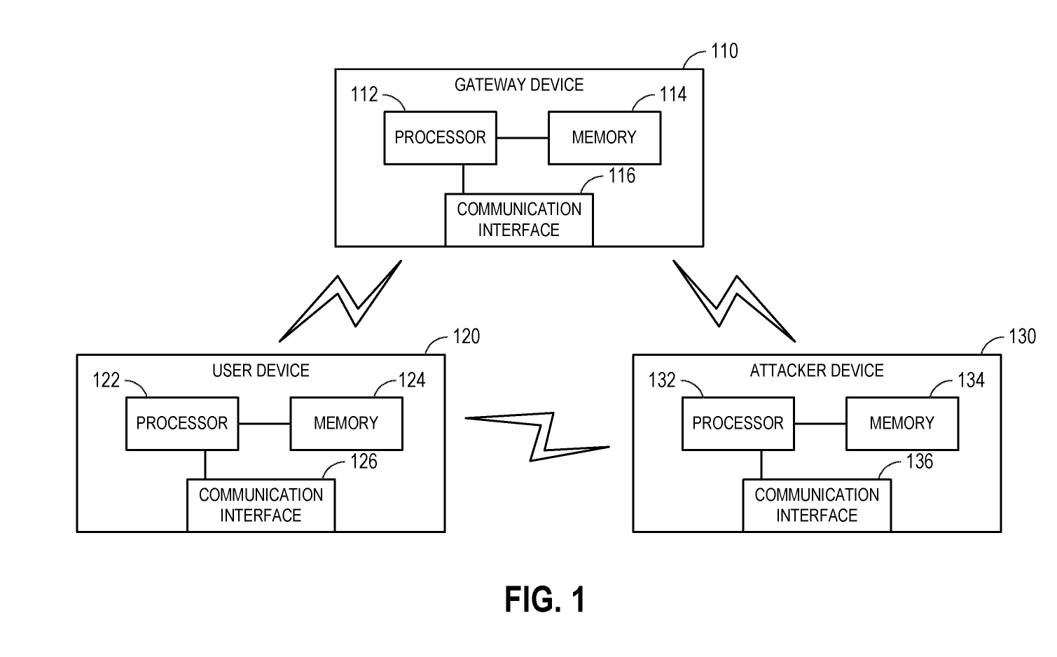

Referring to FIG. 1, a block diagram illustrating an example environment 100 in which embodiments of the disclosure may be practiced is shown. The environment 100 comprises a gateway device 110 (or a router device), a user device 120 (e.g., a computer, a smartphone, etc.), and an attacker device 130 (e.g., a computer, a smartphone, etc.). Hereinafter any reference to a “gateway” shall refer to either a “gateway” or a “router,” as appropriate. Each of the devices 110, 120, 130 may comprise at least a processor 112, 122, 132, a memory 114, 124, 134, and a communication interface 116, 126, 136. The communication interface 116, 126, 136 may be implemented with appropriate hardware and software to enable devices 110, 120, 130 to digitally communicate with each other (and potentially with additional devices in the same local area network “LAN” or in a wider network such as a wide area network “WAN” or the Internet) using one or more suitable networking techniques (e.g., Ethernet, IEEE 802.11 wireless local area network “WLAN,” etc.) and protocols (e.g., the IP protocol suite). In other words, devices 110, 120, 130 may communicate with each other using the IP protocol, and each of the devices 110, 120, 130 may be associated with a MAC address at Layer 2 and an IP address at Layer 3. In one embodiment, the gateway device 110 may also serve as a wireless access point of a WLAN, and the user device 120 may gain access to devices in the LAN, or in a wider network such as a WAN or the Internet by wirelessly associating with the gateway device 110 using the WLAN protocol. It should be appreciated that the beacon frames wirelessly broadcast by a wireless access point contain the MAC address of the wireless access point. In other words, the MAC address of a wireless access point can be obtained from the wireless broadcast beacon frames at the wireless interface.

In each of the devices 110, 120, 130, the memory 114, 124, 134 may store computer code therein which, when executed by the respective processor 112, 122, 132, may causes the processor 112, 122, 132 to perform one or more operations. The operations may include, but are not limited to, manipulating data (e.g., ARP cache) in the memory, or sending/receiving a message (e.g., ARP messages or other data messages) through the communication interface.

Each of the devices 110, 120, 130 may implement, within its respective memory 114, 124, 134, an ARP cache that stores IP address to MAC address mappings for devices in the same IP subnetwork. The ARP cache is constructed based on ARP messages on the subnetwork. Therefore, typically, when a device (e.g., an origin device) intends to send a data frame to another device (e.g., a destination device) associated with an IP address within the same subnetwork, it looks up the destination IP address within its ARP cache. If an entry that maps the destination IP address to the associated MAC address is found in the ARP cache, the data frame at Layer 2 is sent based on the destination MAC address. If an entry for the destination IP address cannot be found in the ARP cache of the origin device, the origin device may broadcast an ARP request message onto the subnetwork, requesting the MAC address associated with the destination IP address. In response to the ARP request message, the destination device may send an ARP response message onto the subnetwork, the ARP response message comprising both its IP address and its MAC address. The ARP response message may also be known as the ARP reply message, and hereinafter the two terms may be used interchangeably. Upon receiving the ARP response message from the destination device, the origin device may store the IP address to MAC address mapping associated with destination device in its ARP cache, and send the data frame based on the destination MAC address. As the mapping has been stored in its ARP cache, if the origin device needs to send another data frame to the same destination address (within a timeout period), another round of ARP query is not required, and the data frame can be sent based on the stored destination MAC address. It should be appreciated that the gateway or router is also a device on the subnetwork, and whenever a user device on this subnetwork needs to communicate with a device outside the subnetwork, the user device needs to communicate through the gateway or router. Embodiments of the disclosure are related to detection and containment of ARP spoofing that involves the gateway or router (which is the most common case). In one embodiment, the WLAN access point for the subnetwork itself functions as the gateway (or router). The MAC address of the WLAN access point can be obtained from beacon frames wirelessly broadcast by the WLAN access point, as described above.

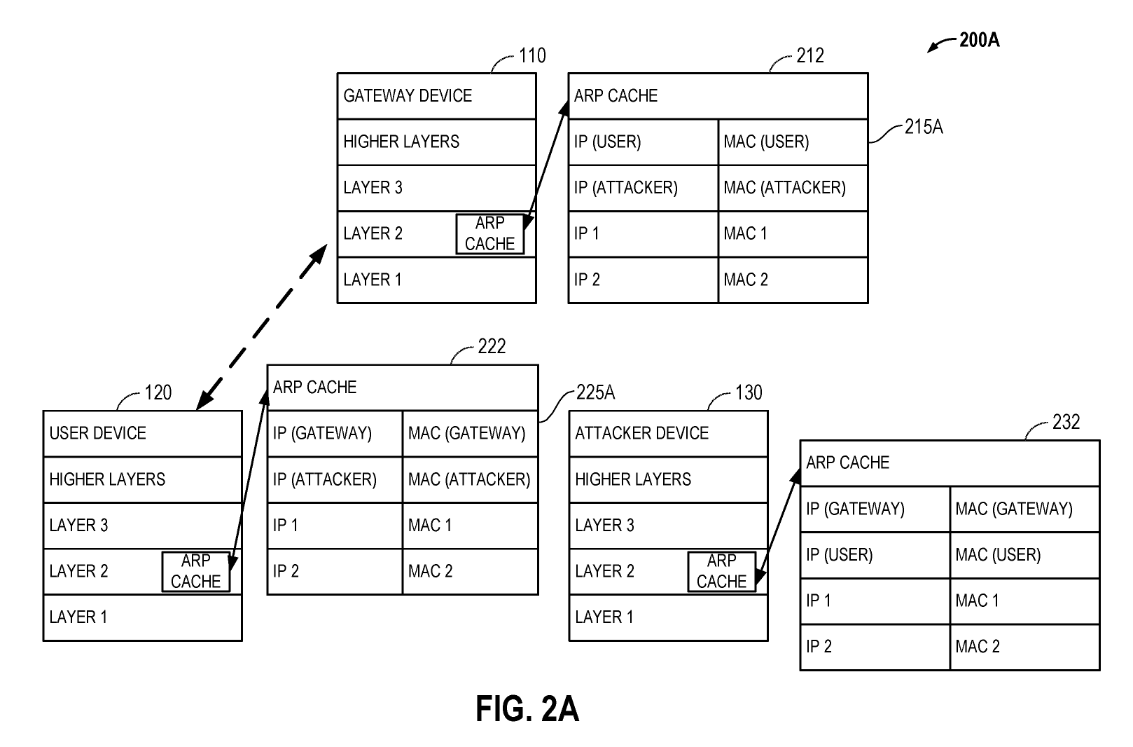

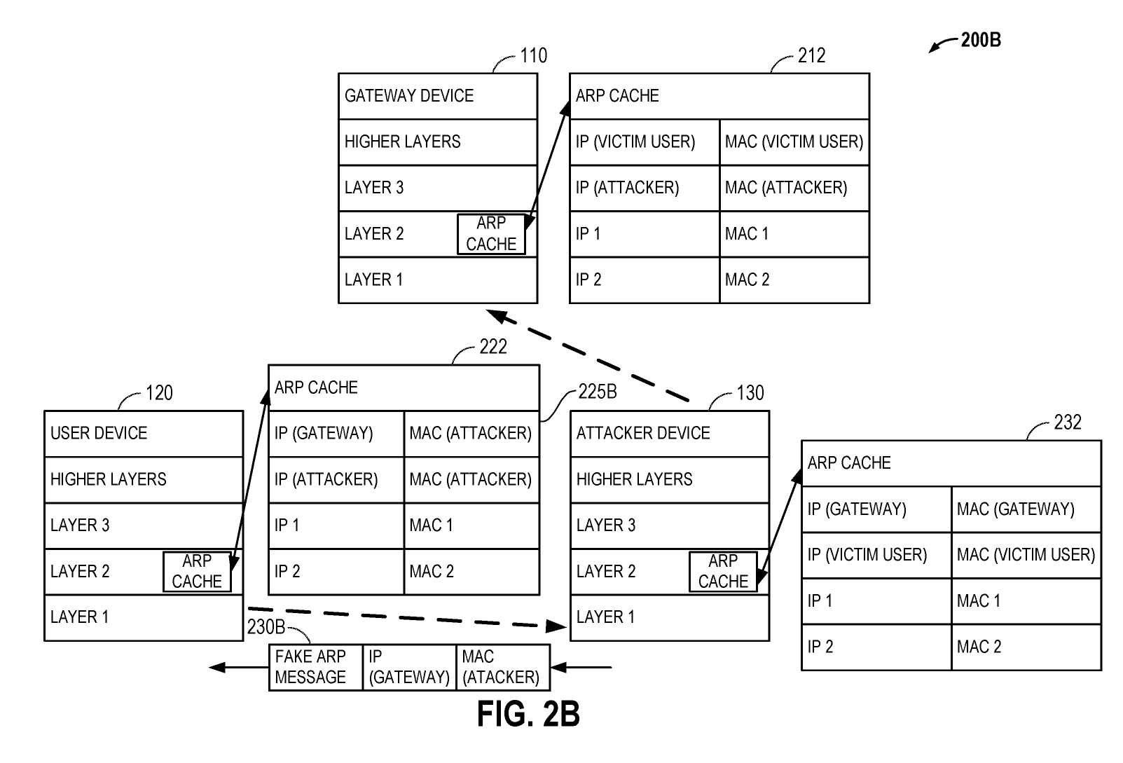

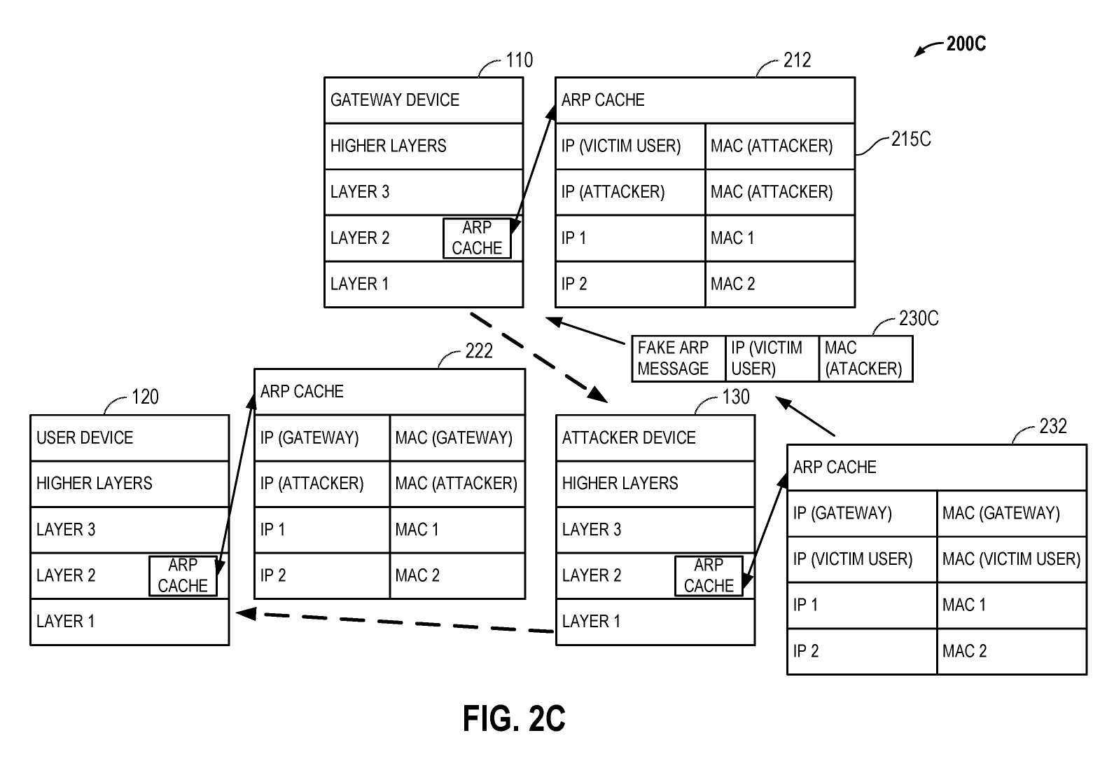

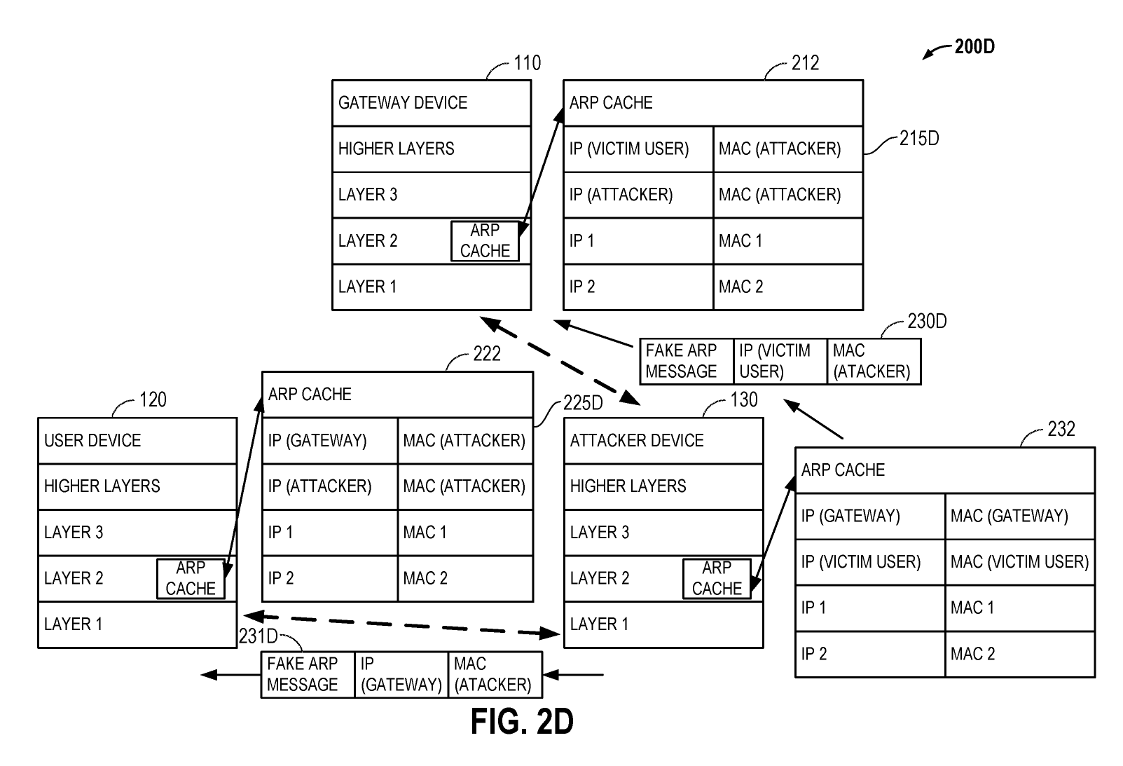

Referring to FIG. 2A, a block diagram illustrating an example scenario 200A in which no ARP cache compromise has occurred is shown. The gateway device 110, user device 120, and attacker device 130 each has an ARP cache 212, 222, 232 that stores IP address to MAC address mappings. In the uncompromised state, the ARP cache 222 of the user device 120 stores the correct mapping 225A for the gateway device 110, and the ARP cache 212 of the gateway device 110 stores the correct mapping 215A for the user device 120. Accordingly, network communications between the user device 120 and the gateway device 110 work properly in either direction.

Referring to FIG. 2B, a block diagram illustrating an example scenario 200B in which the ARP cache of the user device is compromised is shown. The attacker device 130 sends a fake ARP message 230B onto the subnetwork. The fake ARP message 230B associates the IP address of the gateway device 110 with the MAC address of the attacker device 130. As a result of the fake ARP message 230B, the ARP cache 222 of the user device 120 is compromised and now stores an incorrect IP address to MAC address mapping 225B that maps the IP address of the gateway device 110 to the MAC address of the attacker device 130. Accordingly, outgoing network traffic from the user device 120 and intended for the gateway device 110 is not correctly processed by the gateway device 110; instead, such outgoing traffic is intercepted by the attacker device 130. If the attacker device 130 forwards the outgoing traffic from the user device 120 onto the gateway device 110, a MITM attack has occurred. If the attacker device 130 does not forward the outgoing traffic from the user device 120 onto the gateway device 110, a DoS attack has occurred. It should be appreciated that because the outgoing traffic from the user device 120 and intended for destinations outside the same subnetwork needs to be routed through the gateway device 110, a significant portion of the outgoing traffic from the user device 120 may be affected by the attack.

Referring to FIG. 2C, a block diagram illustrating an example scenario 200C in which the ARP cache of the gateway device is compromised is shown. The attacker device 130 sends a fake ARP message 230C onto the subnetwork. The fake ARP message 230C associates the IP address of the user device 120 with the MAC address of the attacker device 130. As a result of the fake ARP message 230C, the ARP cache 212 of the gateway device 110 is compromised and now stores an incorrect IP address to MAC address mapping 215C that maps the IP address of the user device 120 to the MAC address of the attacker device 130. Accordingly, incoming network traffic intended for the user device 120 from the gateway device 110 is not correctly processed by the user device 120; instead, such incoming traffic is intercepted by the attacker device 130. If the attacker device 130 forwards the incoming traffic from the gateway device 110 onto the user device 120, a MITM attack has occurred. If the attacker device 130 does not forward the incoming traffic from the gateway device 110 onto the user device 120, a DoS attack has occurred. It should be appreciated that because the incoming traffic intended for the user device 120 from origins outside the same subnetwork needs to be routed through the gateway device 110, a significant portion of the incoming traffic intended for the user device 120 may be affected by the attack.

Referring to FIG. 2D, a block diagram illustrating an example scenario 200D in which the ARP caches of both the gateway device and the user device are compromised is shown. The attacker device 130 sends two fake ARP messages 230D, 231D onto the subnetwork. The fake ARP message 230D associates the IP address of the user device 120 with the MAC address of the attacker device 130, and the fake ARP message 231D associates the IP address of the gateway device 110 with the MAC address of the attacker device 130. As a result of the fake ARP messages 230D, the ARP cache 212 of the gateway device 110 is compromised and now stores an incorrect IP address to MAC address mapping 215D that maps the IP address of the user device 120 to the MAC address of the attacker device 130. At the same time, as a result of the fake ARP message 231D, the ARP cache 222 of the user device 120 is compromised and now stores an incorrect IP address to MAC address mapping 225D that maps the IP address of the gateway device 110 to the MAC address of the attacker device 130. Accordingly, both incoming network traffic intended for the user device 120 from the gateway device 110 and outgoing network traffic from the user device 120 and intended for the gateway device 110 is not correctly processed by either the user device 120 or gateway device 110; instead, both incoming and outgoing traffic is intercepted by the attacker device 130. If the attacker device 130 forwards the traffic in both directions onto the intended recipient device (e.g., user device 120 or gateway device 110), a MITM attack on traffic in both directions has occurred. If the attacker device 130 does not forward the traffic in either direction onto the intended recipient device (e.g., user device 120 or gateway device 110), a DoS attack has occurred. It should be appreciated that because traffic between the user device 120 and devices outside the same subnetwork needs to be routed through the gateway device 110, a significant portion of the network traffic for the user device 120 may be affected by the attack.

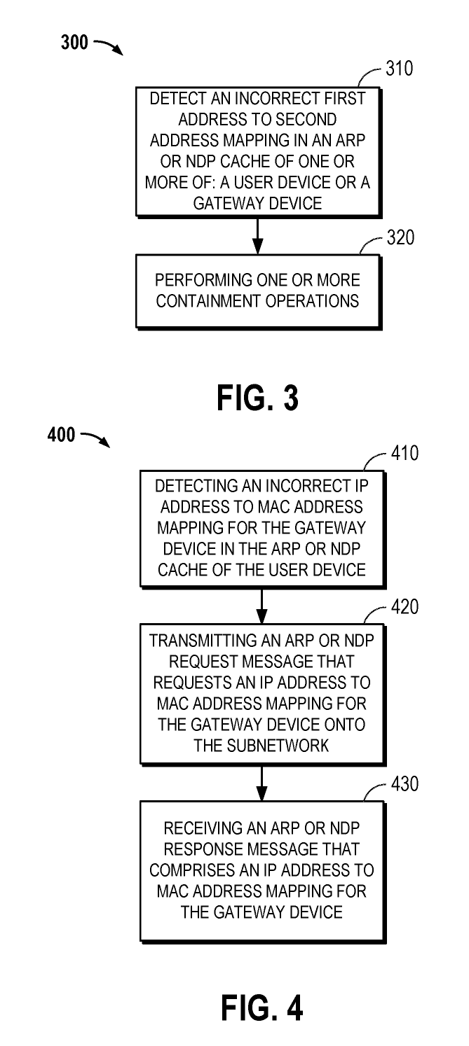

Referring to FIG. 3, a flowchart illustrating an example method 300 for containing an ARP spoof is shown. The method 300 may be implemented at the user device 120. In one embodiment, the method 300 may be implemented entirely as an independent standalone functionality without needing any other support functionality from other networked devices or entities. It should be appreciated that the method 300 does not need any modifications to the existing ARP. At block 310, an incorrect first address to second address mapping in an ARP cache of one or more of: a user device or a gateway device, may be detected. The first address may be an IP address, and the second address may be a MAC address. At block 320, one or more containment operations may be performed. The containment operations may comprise one or more of: transmitting an ARP request message that requests an IP address to MAC address mapping for the gateway device onto the subnetwork, transmitting an ARP message that comprises an IP address to MAC address mapping for the user device onto the subnetwork, or alerting the user.

In one embodiment, the following MAC and IP address information may be obtained from the High Level Operating System (HLOS)/kernel/platform layer of the user device: (1) the MAC address of the WLAN access point, which is known when the user device registers with the access point, and additionally can be known from the WLAN scans yielding the basic service set identifier (BSSID)/MAC address (e.g., from the wirelessly broadcast beacon frames); and (2) the IP address of the gateway (or router). As an example, in Android the IP address of the gateway can be obtained from the “WifiInfo” data structure, which may be the IP address configured by the Dynamic Host Configuration Protocol (DHCP) server. The ARP cache in the user device may then be checked to find if there exists an entry mapping the gateway's IP address to the WLAN access point's MAC address. If such an entry exists, that the WLAN access point itself is working as a gateway (or router) may be assumed. If such an IP address to MAC address mapping does not exist in the ARP cache of the user device, an ARP request message is sent out in the local subnetwork, requesting the MAC address for the IP address of the gateway. If a single ARP response message is received, it is checked to determine if it comprises an IP address to MAC address mapping where the IP address matches the IP address of the gateway and the MAC address matches the MAC address of the WLAN access point. A match would indicate that the WLAN access point is also working as a gateway (or router) for this subnetwork.

Referring to FIG. 4, a flowchart illustrating an example method 400 for containing an ARP spoof that compromises an ARP cache of the user device is shown. The method 400 may be implemented at the user device 120. At block 410, an incorrect IP address to MAC address mapping for the gateway device in the ARP cache of the user device may be detected. Most likely the incorrect mapping is due to an ARP spoofing attack. The incorrect mapping may be detected based upon a mismatch between the MAC address in the IP address to MAC address mapping for the gateway device and the expected MAC address of the gateway device (e.g., the expected MAC address of the gateway device may be the MAC address of the WLAN access point, as described above). In one embodiment, in detecting the incorrect IP address to MAC address mapping, the ARP cache of the user device is not directly examined (i.e., read). Instead, a shadow ARP cache may be constructed, in which entry states may be set (e.g., new neighbor “ADDITION,” stale neighbor “STALE,” delete neighbor “DELETE,” probe neighbor “PROBE”) based on the observed ARP messages. The shadow ARP cache is expected to be consistent with the actual ARP cache; therefore entries in the ARP cache may be determined based on an examination of the shadow ARP cache. In other words, an attempt to overwrite the IP address to MAC address mapping related to the gateway device in the ARP cache of the user device can be detected based on the examination of the shadow ARP cache. In one embodiment, the user device is networked by wirelessly associating with a WLAN access point, and it is assumed that a same device serves both as the WLAN access point and the gateway device (as described above). Accordingly, the expected MAC address of the gateway device is the same as the MAC address of the WLAN access point, which may be obtained from the WLAN interface of the user device (e.g., from the beacon frames wirelessly broadcast by the WLAN access point). At block 420, an ARP request message that requests an IP address to MAC address mapping for the gateway device may be transmitted onto the subnetwork. At block 430, an ARP response message that comprises the IP address to MAC address mapping for the gateway device may be received. It should be appreciated that a correct ARP response message can rectify the incorrect IP address to MAC address mapping (that most likely occurred due to an attacker's ARP spoofing) in the actual ARP cache of the user device.

In one embodiment, a technique known as MAC-Forced Forwarding (MACFF) may be enabled on the local subnetwork. With MACFF, a plurality of IP addresses may be mapped to the same MAC address that belongs to the gateway device. These mappings are not expected to change. Therefore, if an observed ARP message changes the mapping for any of the plurality of IP addresses that have been mapped to the MAC address of the gateway device, it may be assumed that an ARP spoofing attack has occurred. To contain the attack, an ARP request message that requests an IP address to MAC address mapping for the IP address affected by the attack may be transmitted onto the subnetwork. It should be appreciated that to avoid false positives, if a plurality of IP addresses are mapped to a same MAC address that does not belong to the gateway device, an observed ARP message that changes the mapping for any of the plurality of IP addresses is not assumed to be a spoofed message, and no containment operation is performed.

It should be appreciated that transmitting an ARP request message that requests an IP address to MAC address mapping for the gateway device at block 420 would cause the gateway device to transmit an ARP response message that comprises the correct IP address to MAC address mapping for the gateway device. Upon receiving the ARP response message (at block 430) transmitted by the gateway device, the user device should automatically correct the corresponding mapping entry in its ARP cache based on the standard implementation of ARP. However, the attacker device may transmit another spoofed ARP response message in response to the ARP request message in an attempt to prevent the ARP cache entry from being corrected or to compromise the ARP cache entry again. Therefore, receiving two or more different ARP response messages that purport to comprise the IP address to MAC address mapping for the IP address of the gateway device after the transmission of block 420 indicates a new ARP spoofing attempt. In this scenario, the transmission of block 420 may be repeated in order to elicit another real ARP response message from the gateway device. However, if interference by the attacker device through additional spoofed ARP response messages persists, the user may be alerted (e.g., after a predetermined number of attempts at the transmission of block 420), so that the user may take other actions (e.g., using a virtual private network “VPN,” or a different network service, etc.).

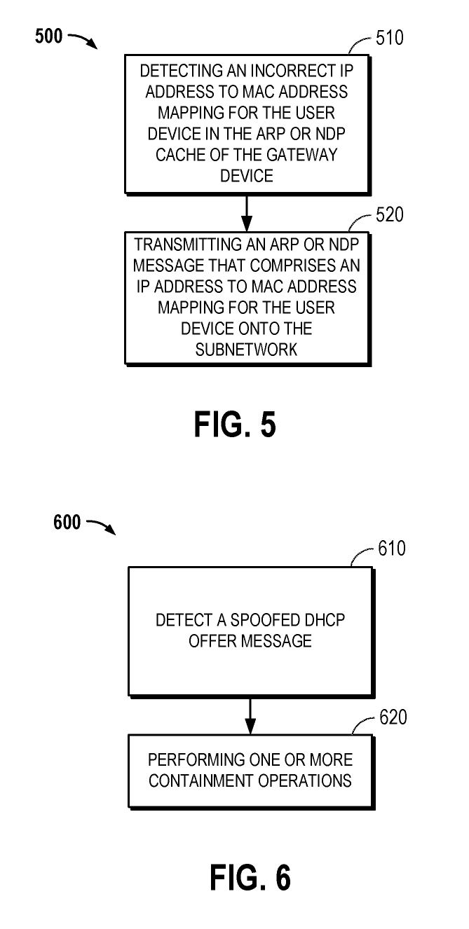

Referring to FIG. 5, a flowchart illustrating an example method 500 for containing an ARP spoof that compromises an ARP cache of the gateway device is shown. The method 500 may be implemented at the user device 120. At block 510, an incorrect IP address to MAC address mapping for the user device in the ARP cache of the gateway device may be detected.

In one embodiment, detecting an incorrect IP address to MAC address mapping for the user device in the ARP cache of the gateway device may comprise sending a ping packet (e.g., an Internet Control Message Protocol “ICMP” Echo Request packet) to the IP address of the gateway device and observing the ping reply packet (e.g., an ICMP Echo Reply packet). If for the ping reply packet, the MAC address of the last sender, as obtained from Layer 2 in the user device, is different from the expected MAC address of the gateway or router device (e.g., the same as that of the WLAN access point), it can be assumed that the IP address to MAC address mapping for the user device in the ARP cache of the gateway device is incorrect or compromised. Hence, it's is a very highly likely case that the incorrect mapping is due to an ARP spoofing attack. It should be appreciated that if the user device receives the ping reply packet directly from the gateway device, the MAC address of the last sender, as determined at Layer 2, should match the MAC address of the gateway device. Accordingly, the fact that the MAC address of the last sender for the pint reply packet does not match the MAC address of the gateway device indicates the presence of a MITM attack (i.e., the ping reply packet is being forwarded by a device other than the gateway device). A MITM attack in the incoming direction (from the gateway device to the user device) indicates that the IP address to MAC address mapping for the user device in the ARP cache of the gateway device is compromised.

In another embodiment, detecting an incorrect IP address to MAC address mapping for the user device in the ARP cache of the gateway device may comprise observing, at Layer 3, packets originating from a device with an IP address outside the local subnetwork, and determining, at Layer2, whether the MAC address of the last sender associated with these packets matches the MAC address of the gateway device. The observation and determination may be performed periodically or from time to time. It should be appreciated that packets originating from a device with an IP address outside the local subnetwork are routed to the user device through the gateway device. Therefore, under normal operation circumstances, the MAC address of the last sender associated with these packets should match the MAC address of the gateway device. Accordingly, the fact that the MAC address of the last sender associated with these packets does not match the MAC address of the gateway device indicates the presence of a MITM attack (i.e., the packets are being forwarded by a device other than the gateway device). A MITM attack in the incoming direction (from the gateway device to the user device) indicates that the IP address to MAC address mapping for the user device in the ARP cache of the gateway device is compromised.

At block 520, an ARP message that comprises an IP address to MAC address mapping for the user device may be transmitted onto the subnetwork. Upon receiving the ARP message transmitted by the user device, the gateway device should correct the mapping entry for the user device in its ARP cache automatically. The detection of block 510 may be repeated to verify that the IP address to MAC address mapping for the user device in the ARP cache of the gateway device has been corrected. Further, the detection of block 510 may be repeated periodically or from time to time to ensure that the mapping entry has not been compromised again. If the containment operation of block 520 fails (e.g., when the attacker device continually sends new spoofed ARP message to compromise the ARP cache of the gateway device), the user may be alerted (e.g., after a predetermined number of attempts at transmission of block 520), so that the user may take other actions (e.g., using a virtual private network “VPN,” or a different network service, etc.).

In one embodiment, if the ARP cache of the gateway device comprises an incorrect IP address to MAC address mapping for the user device (e.g., due to an ARP spoofing attack), and the attack is of the DoS kind (e.g., the attacker device does not forward the traffic from the gateway device onto the user device), the compromise at the ARP cache of the gateway device may be detected based on a failure to receive any response packets to protocol signaling requests within a certain time duration at Layer 3. Once the compromise is detected, the containment operation of block 520 may be performed. However, it should be appreciated that the failure to receive response packets may have other causes (e.g., network connection problems).

As described above, method 400 can be applied when the ARP cache of the user device is compromised, and method 500 can be applied when the ARP cache of the gateway device is compromised. In cases where ARP caches of both the user device and the gateway device are compromised, method 400 and method 500 can be applied in tandem to correct both ARP caches.

Referring to FIG. 6, a flowchart illustrating an example method 600 for containing a DHCP spoofing attack, according to an additional embodiment of the disclosure, is shown. DHCP is a network management protocol whereby a DHCP server dynamically assigns an IP address and other network configuration parameters to each device on a network so they can communicate with other IP networks. The method 600 may be performed at a client device. At block 610, a spoofed DHCP offer message may be detected. The detection of the spoofed DHCP offer message may be based on the likely assumption that a genuine DHCP offer message should come from 1) the gateway or router device that is also acting as a DCHP server, or 2) a DHCP server outside the subnetwork (e.g., beyond the gateway or router device). In either case, the genuine DHCP offer message would be associated with the MAC address of the gateway or router device, because the genuine DHCP offer message is either issued by the gateway or router device directly, or forwarded by the gateway or router device from outside the subnetwork. In case the gateway or router device also acts as a WLAN access point, the MAC address of the gateway or router device can be obtained from the wirelessly broadcast beacon frames. Conversely, if a DHCP offer message is associated with a MAC address other than the MAC address of the gateway or router device, the DHCP offer message comes from another device within the same subnetwork, and can be assumed to be a spoofed DHCP offer message.

In other words, at block 610, a spoofed DHCP offer message may be detected based on a MAC address associate with the DHCP offer message. The spoofed DHCP offer message is detected when the MAC address associate with the DHCP offer message is different from the MAC address of the gateway or router device.

At block 620, one or more containment operations may be performed. The containment operations may comprise one or more of: transmitting a new DHCP discovery message, or alerting a user.

Therefore, embodiments of the disclosure are related to a method, apparatus, and system for effectively detecting and containing ARP spoofing attacks. ARP spoofing attacks are relatively easy to launch, and may cause serious network problems. Not all conventional network side solutions are robust or effective. Embodiments are related to solutions that can be implemented on the user device (e.g., a laptop, smartphone, etc.), so that a user does not have to rely on a properly implemented network side solution for protection against ARP spoofing attacks.

One embodiment of the disclosure is related to an apparatus, comprising a memory; and a processor coupled to the memory, the processor to: detect an incorrect first address to second address mapping in an ARP cache of one or more of: a user device or a gateway device; and perform one or more containment operations, wherein the containment operations comprise one or more of: transmitting an ARP request message that requests an Internet Protocol (IP) address to Media Access Control (MAC) address mapping for a gateway device onto a subnetwork, transmitting an ARP message that comprises an IP address to MAC address mapping for a user device onto the subnetwork, or alerting a user. Embodiments of the disclosure may be used with the default basic NDP that lacks message authentication, as well.

It should be appreciated that aspects of the disclosure previously described may be implemented in conjunction with the execution of instructions (e.g., applications) by processor 122 of device 120, as previously described. Particularly, circuitry of the device, including but not limited to processor, may operate under the control of an application, program, routine, or the execution of instructions to execute methods or processes in accordance with embodiments of the disclosure (e.g., the processes of FIGS. 3-6). For example, such a program may be implemented in firmware or software (e.g., stored in memory and/or other locations) and may be implemented by processors and/or other circuitry of the devices. Further, it should be appreciated that the terms processor, microprocessor, circuitry, controller, etc., refer to any type of logic or circuitry capable of executing logic, commands, instructions, software, firmware, functionality, etc.

Methods described herein may be implemented in conjunction with various wireless communication networks such as a wireless wide area network (WWAN), a wireless local area network (WLAN), a wireless personal area network (WPAN), and so on. The term “network” and “system” are often used interchangeably. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, and so on. A CDMA network may implement one or more radio access technologies (RATs) such as cdma2000, Wideband-CDMA (W-CDMA), and so on. Cdma2000 includes IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may be an IEEE 802.11x network, and a WPAN may be a Bluetooth network, an IEEE 802.15x, or some other type of network. The techniques may also be implemented in conjunction with any combination of WWAN, WLAN and/or WPAN.

Example methods, apparatuses, or articles of manufacture presented herein may be implemented, in whole or in part, for use in or with mobile communication devices. As used herein, “mobile device,” “mobile communication device,” “hand-held device,” “tablets,” etc., or the plural form of such terms may be used interchangeably and may refer to any kind of special purpose computing platform or device that may communicate through wireless transmission or receipt of information over suitable communications networks according to one or more communication protocols, and that may from time to time have a position or location that changes. As a way of illustration, special purpose mobile communication devices, may include, for example, cellular telephones, satellite telephones, smart telephones, heat map or radio map generation tools or devices, observed signal parameter generation tools or devices, personal digital assistants (PDAs), laptop computers, personal entertainment systems, e-book readers, tablet personal computers (PC), personal audio or video devices, personal navigation units, or the like. It should be appreciated, however, that these are merely illustrative examples relating to mobile devices that may be utilized to facilitate or support one or more processes or operations described herein.

The methodologies described herein may be implemented in different ways and with different configurations depending upon the particular application. For example, such methodologies may be implemented in hardware, firmware, and/or combinations thereof, along with software. In a hardware implementation, for example, a processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices units designed to perform the functions described herein, and/or combinations thereof.

The herein described storage media may comprise primary, secondary, and/or tertiary storage media. Primary storage media may include memory such as random access memory and/or read-only memory, for example. Secondary storage media may include mass storage such as a magnetic or solid state hard drive. Tertiary storage media may include removable storage media such as a magnetic or optical disk, a magnetic tape, a solid state storage device, etc. In certain implementations, the storage media or portions thereof may be operatively receptive of, or otherwise configurable to couple to, other components of a computing platform, such as a processor.

In at least some implementations, one or more portions of the herein described storage media may store signals representative of data and/or information as expressed by a particular state of the storage media. For example, an electronic signal representative of data and/or information may be “stored” in a portion of the storage media (e.g., memory) by affecting or changing the state of such portions of the storage media to represent data and/or information as binary information (e.g., ones and zeroes). As such, in a particular implementation, such a change of state of the portion of the storage media to store a signal representative of data and/or information constitutes a transformation of storage media to a different state or thing.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter.

Some portions of the preceding detailed description have been presented in terms of algorithms or symbolic representations of operations on binary digital electronic signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated as electronic signals representing information. It has proven convenient at times, principally for reasons of common usage, to refer to such signals as bits, data, values, elements, symbols, characters, terms, numbers, numerals, information, or the like. It should be understood, however, that all of these or similar terms are to be associated with appropriate physical quantities and are merely convenient labels.

Unless specifically stated otherwise, as apparent from the following discussion, it is appreciated that throughout this specification discussions utilizing terms such as “processing,” “computing,” “calculating,”, “identifying”, “determining”, “establishing”, “obtaining”, and/or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device. In the context of this particular patent application, the term “specific apparatus” may include a general purpose computer once it is programmed to perform particular functions pursuant to instructions from program software.

Reference throughout this specification to “one example”, “an example”, “certain examples”, or “exemplary implementation” means that a particular feature, structure, or characteristic described in connection with the feature and/or example may be included in at least one feature and/or example of claimed subject matter. Thus, the appearances of the phrase “in one example”, “an example”, “in certain examples” or “in some implementations” or other like phrases in various places throughout this specification are not necessarily all referring to the same feature, example, and/or limitation. Furthermore, the particular features, structures, or characteristics may be combined in one or more examples and/or features.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all aspects falling within the scope of appended claims, and equivalents thereof.

What is claimed is:

1. A method, comprising:
detecting an incorrect first address to second address mapping in an Address Resolution Protocol (ARP) cache of one or more of: a user device or a gateway device; and
performing one or more containment operations, wherein the containment operations comprise one or more of: transmitting an ARP request message that requests an Internet Protocol (IP) address to Media Access Control (MAC) address mapping for a gateway device onto a subnetwork, transmitting an ARP message that comprises an IP address to MAC address mapping for a user device onto the subnetwork, or alerting a user.

2. The method of claim 1, wherein detecting the incorrect first address to second address mapping in the ARP cache of one or more of: the user device or the gateway device further comprises: detecting an incorrect IP address to MAC address mapping for the gateway device in the ARP cache of the user device, and wherein the containment operations comprise: transmitting the ARP request message that requests an IP address to MAC address mapping for the gateway device onto the subnetwork; and receiving an ARP response message that comprises the IP address to MAC address mapping for the gateway device.

3. The method of claim 2, wherein detecting the incorrect IP address to MAC address mapping for the gateway device in the ARP cache of the user device comprises constructing and observing a shadow ARP cache at the user device.

4. The method of claim 2, wherein detecting the incorrect IP address to MAC address mapping for the gateway device in the ARP cache of the user device comprises detecting a mismatch between a MAC address in the IP address to MAC address mapping for the gateway device and an expected MAC address of the gateway device.

5. The method of claim 4, wherein the expected MAC address of the gateway device is a MAC address of a Wireless Local Area Network (WLAN) access point.

6. The method of claim 2, wherein a plurality of IP addresses are mapped to a MAC address associated with the gateway device.

7. The method of claim 1, wherein detecting the incorrect first address to second address mapping in the ARP cache of one or more of: the user device or the gateway device further comprises: detecting an incorrect IP address to MAC address mapping for the user device in the ARP cache of the gateway device, and wherein the containment operations comprise: transmitting an ARP message that comprises an IP address to MAC address mapping for the user device onto the subnetwork.

8. The method of claim 7, wherein detecting the incorrect IP address to MAC address mapping for the user device in the ARP cache of the gateway device comprises transmitting a ping packet to an IP address of the gateway device and observing a ping reply packet.

9. The method of claim 8, wherein the incorrect IP address to MAC address mapping for the user device in the ARP cache of the gateway device is detected when for the ping reply packet, a MAC address of a last sender is different from an expected MAC address of the gateway device.

10. The method of claim 7, wherein detecting the incorrect IP address to MAC address mapping for the user device in the ARP cache of the gateway device comprises observing a packet originating from a device with an IP address outside the subnetwork, wherein the incorrect IP address to MAC address mapping for the user device in the ARP cache of the gateway device is detected when a MAC address of a last sender associated with the packet originating from the device with the IP address outside the subnetwork is different from an expected MAC address of the gateway device.

11. The method of claim 1, wherein the detected ARP spoof causes ARP caches of both the user device and the gateway device to be compromised, and wherein the spoofing containment operations comprise both of: 1) transmitting the ARP request message that requests an Internet Protocol (IP) address to Media Access Control (MAC) address mapping for a gateway device onto a subnetwork, and 2) transmitting the ARP message that comprises an IP address to MAC address mapping for a user device onto the subnetwork.

12. The method of claim 1, wherein the gateway device is a router.

13. An apparatus, comprising
a memory; and
a processor coupled to the memory, the processor to:
detect an incorrect first address to second address mapping in an Address Resolution Protocol (ARP) cache of one or more of: a user device or a gateway device; and
perform one or more containment operations, wherein the containment operations comprise one or more of: transmitting an ARP request message that requests an Internet Protocol (IP) address to Media Access Control (MAC) address mapping for a gateway device onto a subnetwork, transmitting an ARP message that comprises an IP address to MAC address mapping for a user device onto the subnetwork, or alerting a user.

14. The apparatus of claim 13, wherein detecting the incorrect first address to second address mapping in the ARP cache of one or more of: the user device or the gateway device further comprises: detecting an incorrect IP address to MAC address mapping for the gateway device in the ARP cache of the user device, and wherein the containment operations comprise: transmitting the ARP request message that requests an IP address to MAC address mapping for the gateway device onto the subnetwork; and receiving an ARP response message that comprises the IP address to MAC address mapping for the gateway device.

15. The apparatus of claim 14, wherein detecting the incorrect IP address to MAC address mapping for the gateway device in the ARP cache of the user device comprises constructing and observing a shadow ARP cache at the user device.

16. The apparatus of claim 14, wherein detecting the incorrect IP address to MAC address mapping for the gateway device in the ARP cache of the user device comprises detecting a mismatch between a MAC address in the IP address to MAC address mapping for the gateway device and an expected MAC address of the gateway device.

17. The apparatus of claim 16, wherein the expected MAC address of the gateway device is a MAC address of a Wireless Local Area Network (WLAN) access point.

18. The apparatus of claim 14, wherein a plurality of IP addresses are mapped to a MAC address associated with the gateway device.

19. The apparatus of claim 13, wherein detecting the incorrect first address to second address mapping in the ARP cache of one or more of: the user device or the gateway device further comprises: detecting an incorrect IP address to MAC address mapping for the user device in the ARP cache of the gateway device, and wherein the containment operations comprise: transmitting an ARP message that comprises an IP address to MAC address mapping for the user device onto the subnetwork.

20. The apparatus of claim 19, wherein detecting the incorrect IP address to MAC address mapping for the user device in the ARP cache of the gateway device comprises transmitting a ping packet to an IP address of the gateway device and observing a ping reply packet.

21. The apparatus of claim 20, wherein the incorrect IP address to MAC address mapping for the user device in the ARP cache of the gateway device is detected when for the ping reply packet, a MAC address of a last sender is different from an expected MAC address of the gateway device.

22. The apparatus of claim 19, wherein detecting the incorrect IP address to MAC address mapping for the user device in the ARP cache of the gateway device comprises observing a packet originating from a device with an IP address outside the subnetwork, wherein the incorrect IP address to MAC address mapping for the user device in the ARP cache of the gateway device is detected when a MAC address of a last sender associated with the packet originating from the device with the IP address outside the subnetwork is different from an expected MAC address of the gateway device.

23. A method for containing a Dynamic Host Configuration Protocol (DHCP) spoofing attack, comprising:
detecting a spoofed DHCP offer message; and
performing one or more containment operations.

24. The method of claim 23, wherein the spoofed DHCP offer message is detected based on a Media Access Control (MAC) address associated with a DHCP offer message.

25. The method of claim 24, wherein the spoofed DHCP offer message is detected when the MAC address associated with the DHCP offer message is different from a MAC address associated with a gateway or router device.

26. The method of claim 25, wherein the gateway or router device acts as a wireless local area network (WLAN) access point, and the MAC address associated with the gateway or router device is obtained from wirelessly broadcast beacon frames.

27. The apparatus of claim 23, wherein the one or more containment operations comprise: transmitting a new DHCP discovery message, or alerting a user.

28. A non-transitory computer-readable medium comprising code which, when executed by a processor, causes the processor to perform a method, the method comprising:
detecting an incorrect first address to second address mapping in an Address Resolution Protocol (ARP) cache of one or more of: a user device or a gateway device; and
performing one or more containment operations, wherein the containment operations comprise one or more of: transmitting an ARP request message that requests an Internet Protocol (IP) address to Media Access Control (MAC) address mapping for a gateway device onto a subnetwork, transmitting an ARP message that comprises an IP address to MAC address mapping for a user device onto the subnetwork, or alerting a user.

29. The non-transitory computer-readable medium of claim 28, wherein code for detecting the incorrect first address to second address mapping in the ARP cache of one or more of: the user device or the gateway device further comprises: code for detecting an incorrect IP address to MAC address mapping for the gateway device in the ARP cache of the user device, and wherein the containment operations comprise: transmitting the ARP request message that requests an IP address to MAC address mapping for the gateway device onto the subnetwork; and receiving an ARP response message that comprises the IP address to MAC address mapping for the gateway device.

30. The non-transitory computer-readable medium of claim 28, wherein code for detecting the incorrect first address to second address mapping in the ARP cache of one or more of: the user device or the gateway device further comprises: code for detecting an incorrect IP address to MAC address mapping for the user device in the ARP cache of the gateway device, and wherein the containment operations comprise: transmitting an ARP message that comprises an IP address to MAC address mapping for the user device onto the subnetwork.
